(19) United States
(12) Patent Application Publication
(10) Pub. No.: US 2006/0031603 A1
(43) Pub. Date: Feb. 9, 2006

(54) Multi-threaded/multi-issue DMA engine data transfer system

(76) Inventors: Travis Alister Bradfield, Colorado Springs, CO (US); Timothy E. Hoglund, Colorado Springs, CO (US); David Weber, Monument, CO (US)

Correspondence Address: LSI Logic Corporation;Legal Department - IP, 1621 Barber Lane, MS D-106, Milpitas, CA, 95035, US

(21) Appl. No.: 10/914,302

(22) Filed: Aug. 9, 2004

(51) Int. Cl. G06F 13/28

(52) U.S. Cl. 710/22

(57) ABSTRACT

A multi-threaded DMA engine data transfer system for a data processing system and a method for transferring data in a data processing system. The DMA Engine data transfer system has at least one frame buffer for storing data transmitted or received over an interface. A multi-threaded DMA engine generates a plurality of requests to transfer data over the interface, processes the plurality of requests using the at least one frame buffer, and completes the transfer requests. The multi-threaded DMA engine data transfer system processes a plurality of data transfer requests simultaneously resulting in improved data throughput performance.

### BACKGROUND OF THE INVENTION

1. Technical Field

The present invention is directed generally toward the data processing field, and more particularly, to a multi-threaded/multi-issue DMA engine data transfer system, and to a method for transferring data in a data processing system.

2. Description of the Related Art

A Direct Memory Access (DMA) engine is incorporated in a controller in a data processing system to assist in transferring data between a computer and a peripheral device of the data processing system. A DMA engine can be described as a hardware assist to a microprocessor in normal Read/Write operations of data transfers that are typically associated with a host adapter in a storage configuration.

A DMA engine can be programmed to automatically fetch and store data to particular memory addresses specified by certain data structures. In such an implementation, the DMA engine can be considered as a “program it once, let it run, and interrupt on completion of the input/output” engine. An embedded microprocessor programs the DMA engine with a starting address of a data structure. In turn, the DMA engine fetches the data structure, processes the data structure and determines to either grab data from or push data to a data transfer interface.

Known DMA engines are single-threaded in that each data structure is requested, processed and the transfer completed before another data structure can be requested. For example, consider that a 2KByte data structure is to be transferred from a first interface to a second interface in 512 Byte chunks. A single-threaded DMA engine requests a 512 Byte transfer from the first interface, then processes the transfer, and then completes the transfer request before generating a request for the next 512 Byte chunk of data. In certain implementations of controllers, for example, 2 GFibre Channel controllers, operation of a single-threaded DMA engine can cause bottlenecks in the dataflow that can affect data throughput performance.

There is, accordingly, a need for a DMA engine data transfer system in a data processing system that provides improved data throughput performance.

### SUMMARY OF THE INVENTION

The present invention provides a multi-threaded DMA engine data transfer system for a data processing system and a method for transferring data in a data processing system. The DMA Engine data transfer system has at least one frame buffer for storing data transmitted or received over an interface. A multi-threaded DMA engine generates a plurality of requests to transfer data over the interface, processes the plurality of requests using the at least one frame buffer, and completes the transfer requests. The multi-threaded DMA engine data transfer system processes a plurality of data transfer requests simultaneously resulting in improved data throughput performance.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a pictorial representation of a network of data processing systems in which the present invention may be implemented;

FIG. 2 is a block diagram of a data processing system that may be implemented as a server in the network of data processing systems of FIG. 1;

FIG. 3 is a block diagram of a data processing system that may be implemented as a client in the network of data processing systems of FIG. 1;

FIG. 4 is a functional block diagram that illustrates a multi-threaded DMA engine data transfer system in accordance with a preferred embodiment of the present invention;

FIG. 5A is a schematic illustration of a data structure relating to data blocks found in a data processing system memory to assist in explaining preferred embodiments of the present invention;

FIG. 5B is a schematic illustration of a memory in a data processing system to assist in explaining preferred embodiments of the present invention;

FIG. 6A is a schematic illustration of a virtual data traffic flow over a PCI(X) interface in accordance with a preferred embodiment of the present invention;

FIG. 6B is a schematic illustration of how the virtual data traffic flow illustrated in FIG. 6A is packaged and transferred at a destination frame buffer in accordance with a preferred embodiment of the present invention;

FIG. 7A is a schematic illustration of virtual data traffic flow over a PCI(X) interface in accordance with a preferred embodiment of the present invention;

FIG. 7B is a schematic illustration of how the virtual data traffic flow illustrated in FIG. 7A is packaged and transferred at a destination frame buffer in accordance with a preferred embodiment of the present invention;

FIG. 8 illustrates a State Machine that shows tag structure employed to associate each outstanding thread used by the multi-threaded DMA engine in accordance with a preferred embodiment of the present invention;

FIG. 9 illustrates a State Machine employed in the multi-threaded DMA engine in accordance with a preferred embodiment of the present invention; and

FIG. 10 is a flowchart that illustrates a method for transferring data in a data processing system in accordance with a preferred embodiment of the present invention.

### DETAILED DESCRIPTION

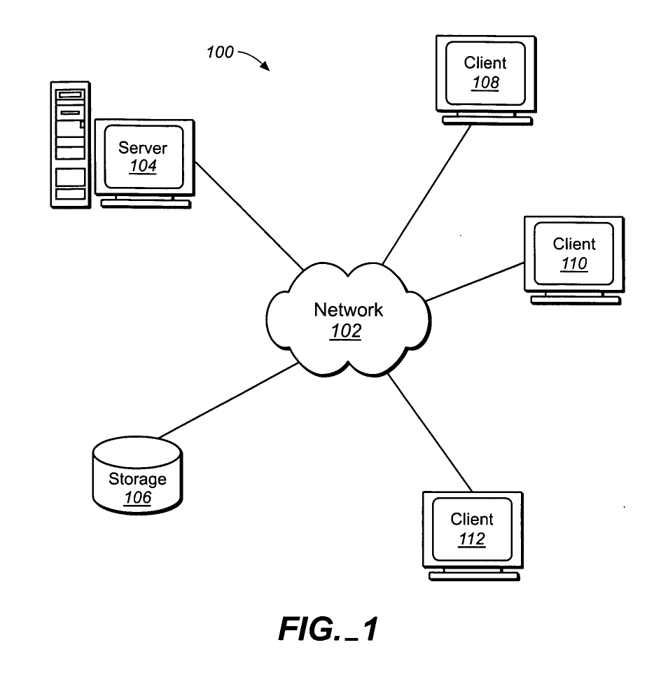

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

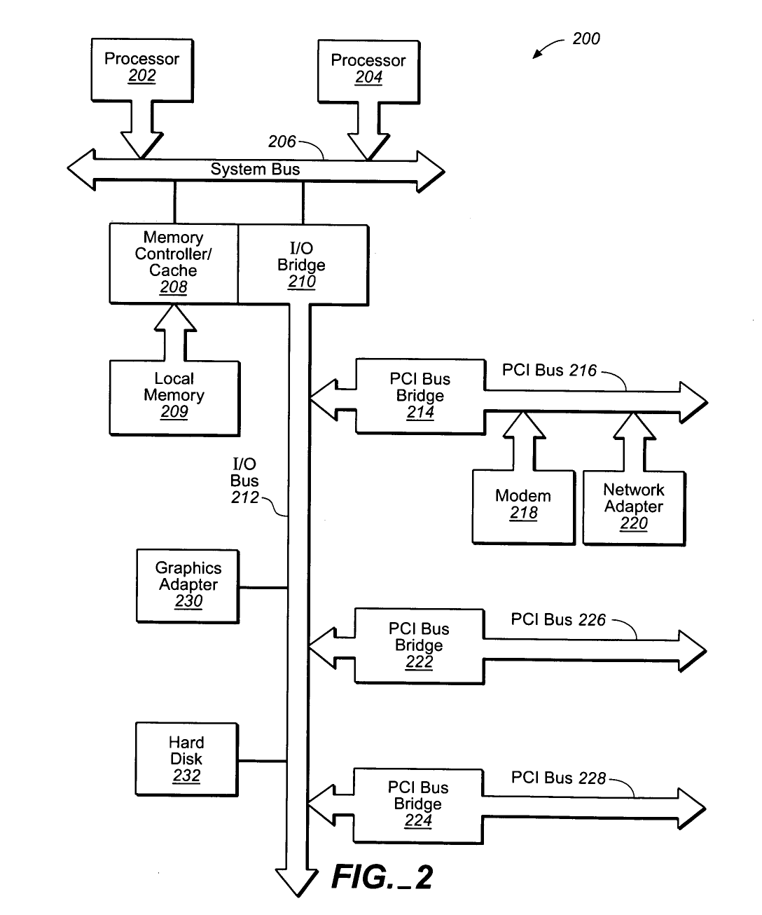

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

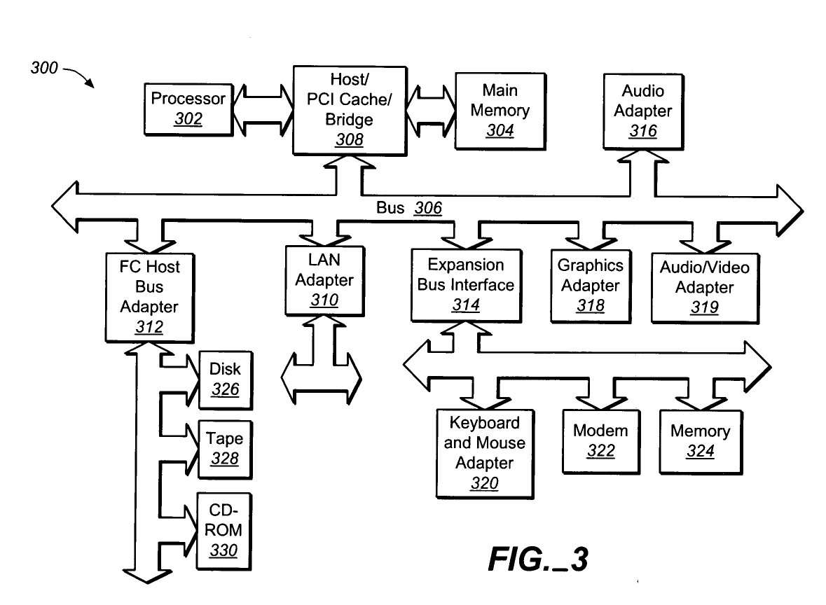

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, Fibre Channel (FC) host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. FC host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces. As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

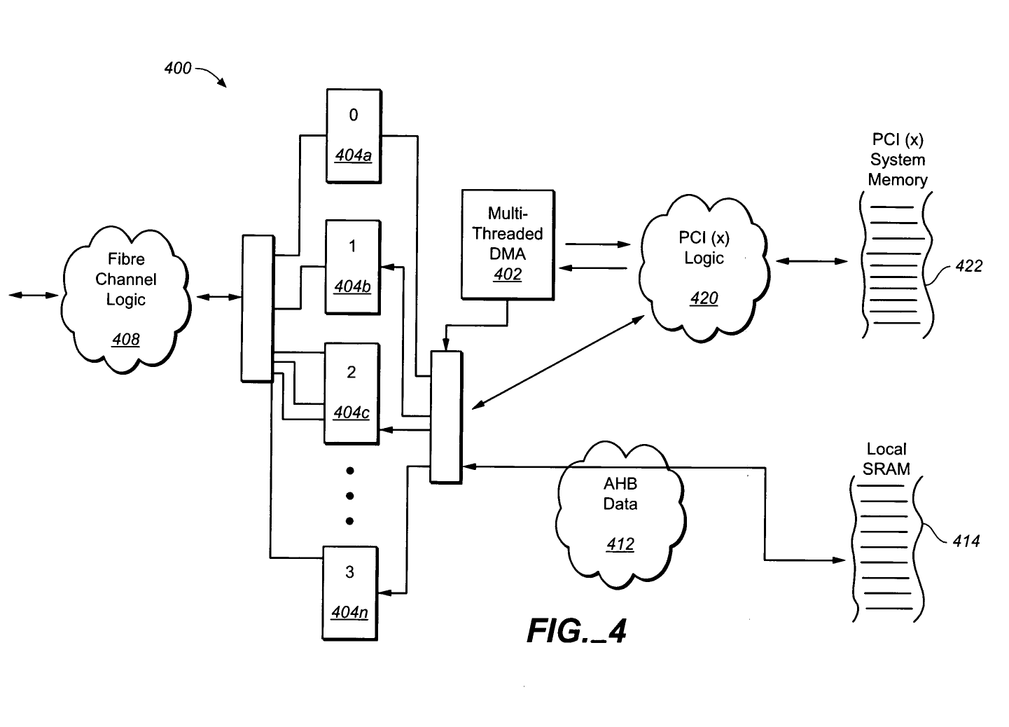

FIG. 4 is a functional block diagram that illustrates a multi-threaded DMA engine data transfer system in accordance with a preferred embodiment of the present invention. The multi-threaded DMA engine data transfer system is generally designated by reference number 400, and includes multi-threaded DMA engine 402 and at least one frame buffer. In the preferred embodiment illustrated in FIG. 4, a specified plurality of frame buffers 404a, 404b, 404c, . . . 404n are illustrated. Multi-threaded DMA engine 402 functions to move data into and out of the plurality of frame buffers 404a, 404b, 404c . . . 404n for transmitting data to and receiving data from interface 408, for example, a Fibre Channel (FC) interface.

Multi-threaded DMA engine data transfer system 400 has three interfaces including, in addition to FC interface 408, Advanced High Speed Bus (AHB) interface 412 for local (on-chip) data, e.g., to/from a local SRAM (Static Random Access Memory) 414, and enhanced peripheral interconnect (PCI(X)) interface 420 for data traffic, for example, to/from data processing system memory 422. Multi-threaded DMA engine 402 generates command requests for system data transfers over PCI(X) interface 420.

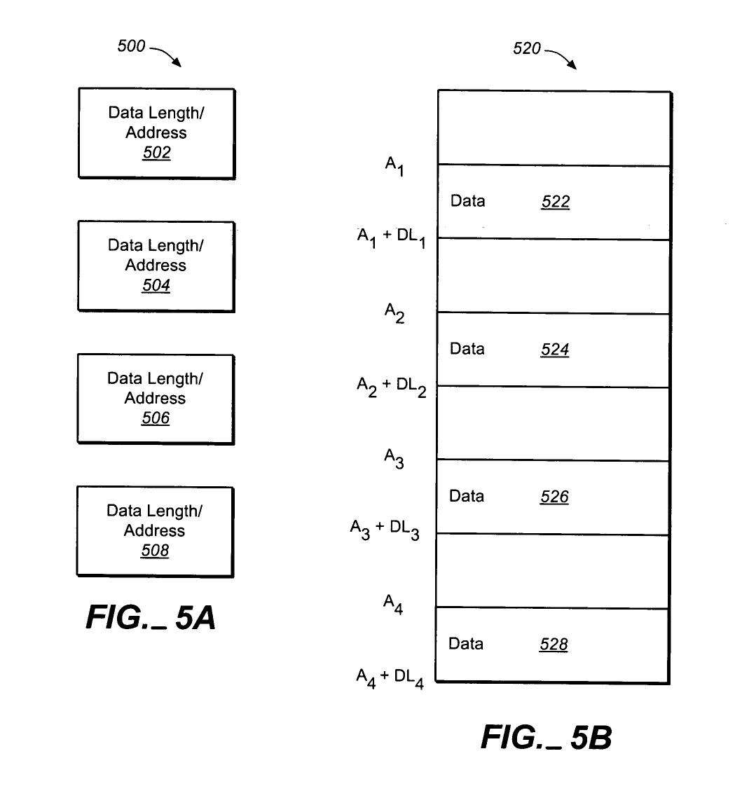

FIG. 5A is a schematic illustration of a data structure relating to data blocks found in a data processing system memory to assist in explaining preferred embodiments of the present invention. The data structure illustrated in FIG. 5A includes four data elements 502, 504, 506 and 508 that are referred to as Scatter Gather elements (SGEs). Each SGE 502, 504, 506 and 508 contains a System Address/Data Length (DL) pair corresponding to where a data block is to be manipulated. A list of SGEs is referred to as a Scatter Gather list (SGL), and in FIG. 5A, SGL 500 is list of SGEs 502, 504, 506 and 508. Each SGE entry in SGL 500 is a primary element operated on by multi-threaded DMA Engine 402 illustrated in FIG. 4.

FIG. 5B is a schematic illustration of a memory in a data processing system, for example, memory 422 in FIG. 4, to assist in explaining preferred embodiments of the present invention. In a multi-threaded operation, multi-threaded DMA Engine 402 is capable of processing and issuing all four outstanding data elements 502, 504, 506 and 508 in SGL 500 for data transfer. As shown in FIG. 5B, memory 520 includes data blocks 522, 524, 526 and 528 which may correspond to data blocks 502, 504, 506 and 508 illustrated in FIG. 5A. Data block 522 is stored in memory 520 beginning at address A₁ and ending at address A₁+DL₁. Similarly, data block 524 is stored in memory 520 beginning at address A₂ and ending at address A₂+DL₂, data block 526 is stored in memory 520 beginning at address A₃ and ending at address A₃+DL₃ and data block 528 is stored in memory 520 beginning at address A₄ and ending at address A₄+DL₄.

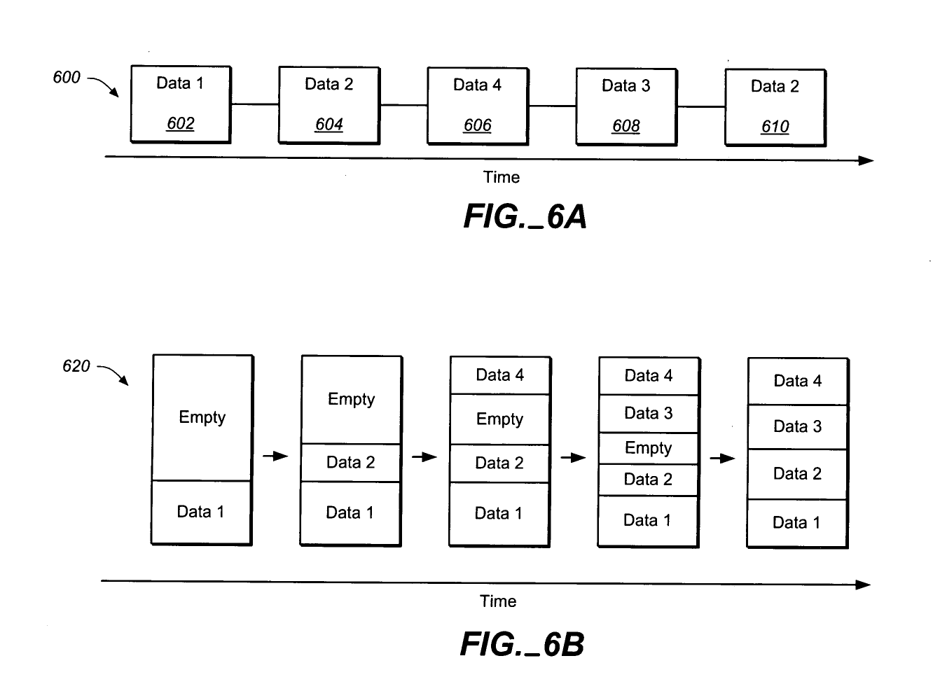

FIG. 6A is a schematic illustration of a virtual data traffic flow over a PCI(X) interface in accordance with a preferred embodiment of the present invention. FIG. 6A illustrates the order of transfer of four data elements 1-4, for example, SGEs 502, 504, 506 and 508 illustrated in FIG. 5A, and illustrates that the elements are transferred in the following order: data block 1 602, data block 2 604, data block 4 606, data block 3 608 and data block 2 610.

FIG. 6B is a schematic illustration of how the virtual data traffic flow illustrated in FIG. 6A is packaged and transferred at a destination frame buffer. In particular, FIG. 6B shows how each outstanding thread, i.e., each SGE entry for data, is transferred and packaged at destination frame buffer 620. In FIG. 6B, the PCI(X) interface can reorder and split data requests. The multi-thread DMA engine packages each data transfer appropriately for frame transmission over the Fibre Channel interface. The data is ready for transfer when frame buffer 620 is filled. The preferred embodiment illustrated in FIGS. 6A and 6B shows an Outbound Frame transmitted over the FC interface. This can be reversed to show a Frame reception over the FC interface.

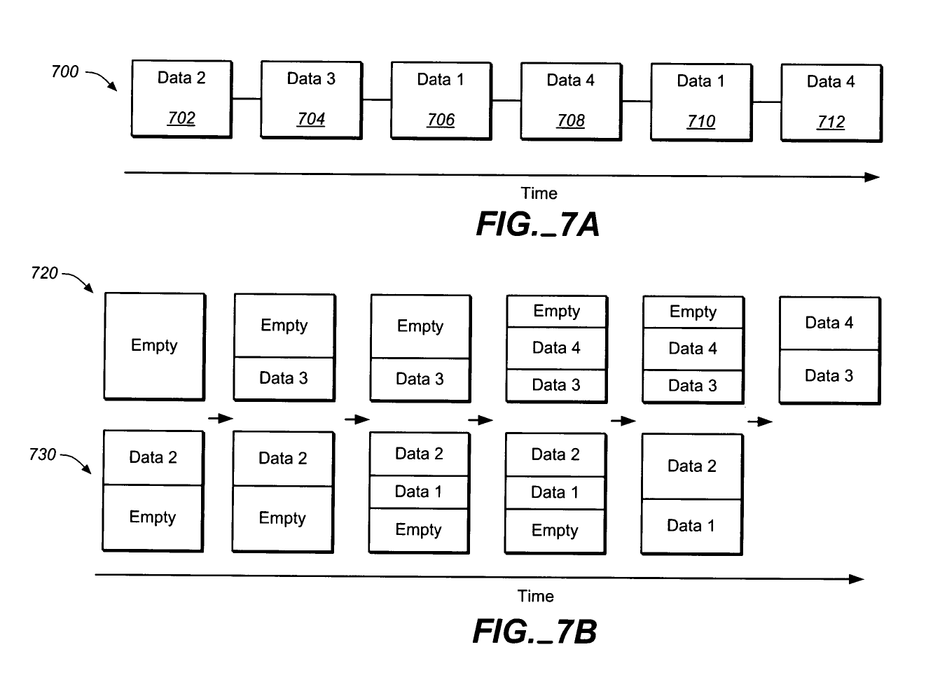

FIG. 7A is a schematic illustration of virtual data traffic flow over a PCI(X) interface in accordance with a preferred embodiment of the present invention, and FIG. 7B is a schematic illustration of how the virtual data traffic flow illustrated in FIG. 7A is packaged and transferred at a destination frame buffer in accordance with a preferred embodiment of the present invention. The embodiment illustrated in FIGS. 7A and 7B differs from the embodiment illustrated in FIGS. 6A and 6B in that in FIGS. 7A and 7B, outstanding tags refer to two frame buffers worth of data to be transferred over the Fibre Channel interface. FIG. 7A illustrates data elements 1, 2, 3 and 4 being transferred in the following order: data block 2 702, data block 3 704, data block 1 706, data block 4 708, data block 1 710 and data block 4 712. FIG. 7B illustrates how the data is packaged and transferred over the Fibre Channel interface using two frame buffers 720 and 730. As is evident in FIG. 7B, it is up to the multi-threaded DMA Engine to package the data and transmit frames in order over the Fibre Channel interface. Data is ready to be transferred when each of frame buffers 720 and 730 become filled. FIG. 7B illustrates a transmission over the Fibre Channel interface, however, this can be reversed to exemplify a Frame reception.

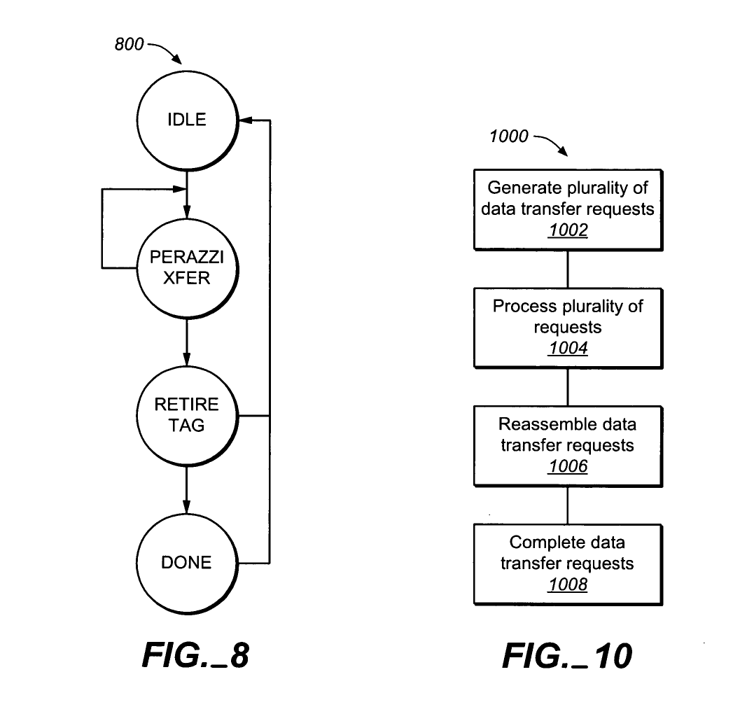

FIG. 8 illustrates a State Machine that shows tag structure 800 employed to associate each outstanding thread used by multi-threaded DMA engine 402 in accordance with a preferred embodiment of the present invention. Each tag structure has the following attributes:
1. Tag—unique identifier
2. Length—data length of the data element to be transferred
3. Buffer Pointer—pointer to the associated frame buffer
4. Address—address indexing into the frame buffer—pointed to by the Buffer Pointer
5. System Address—the system address where the data element is found
6. Valid—signifies if the Tag is outstanding

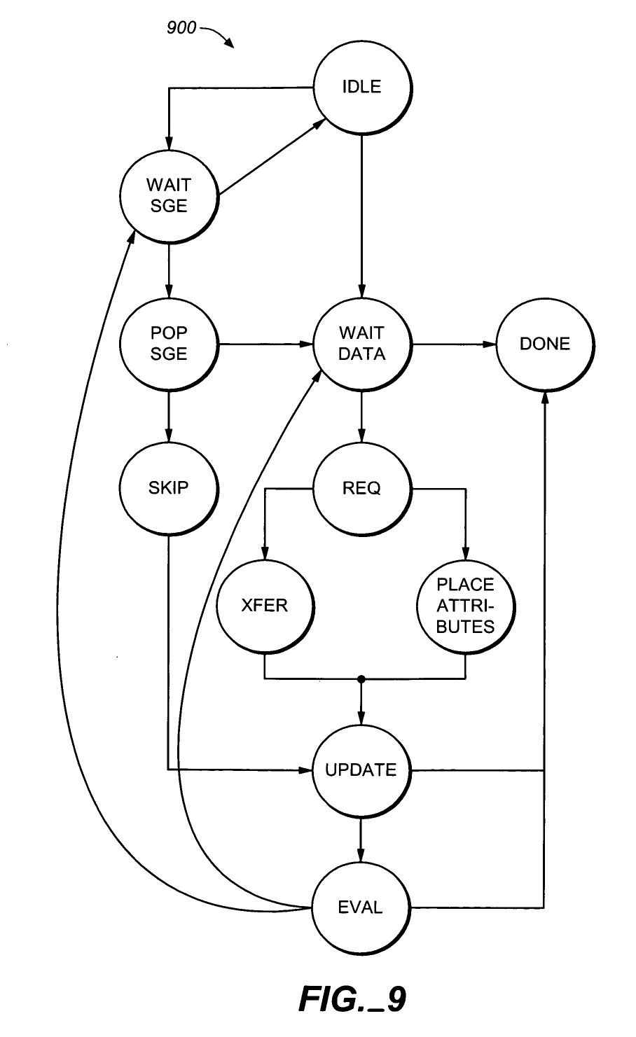

FIG. 9 illustrates a State Machine 900 employed in the multi-threaded DMA engine in accordance with a preferred embodiment of the present invention.

FIG. 10 is a flowchart that illustrates a method for transferring data in a data processing system in accordance with a preferred embodiment of the present invention. The method is generally designated by reference number 1000, and begins by a DMA engine generating a plurality of requests to transfer data over an interface (step 1002). The plurality of requests to transfer data is processed in any desired order (step 1004), reassembled at a destination (step 1006) and the transfer requests are completed (step 1008).

The present invention thus provides a multi-threaded DMA engine data transfer system and a method for transferring data in a data processing system. The multi-threaded DMA engine data transfer system includes at least one frame buffer for storing data transmitted or received over an interface. A multi-threaded DMA engine generates a plurality of requests to transfer data over the interface, processes the plurality of requests using the at least one frame buffer and then completes the transfer requests. The multi-threaded DMA engine data transfer system processes a plurality of data transfer requests simultaneously resulting in improved data throughput performance.

The description of the preferred embodiment of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention the practical application to enable others of ordinary skill in the art to understand the invention for various embodiments with various modifications as are suited to the particular use contemplated.

What is claimed is:

1. A method for transferring data in a data processing system, comprising:
a multi-threaded DMA engine generating a plurality of requests to transfer data over an interface;
the multi-threaded DMA engine processing the plurality of requests using at least one frame buffer; and
the multi-threaded DMA engine completing the plurality of requests.

2. The method according to claim 1, wherein the multi-threaded DMA engine processes the plurality of requests in a desired order, and wherein the method further includes the multi-threaded DMA engine reassembling the plurality of data requests after processing the plurality of requests in the desired order.

3. The method according to claim 1, wherein the at least one frame buffer comprises a plurality of frame buffers, and wherein the multi-threaded DMA engine processes the plurality of requests using the plurality of frame buffers.

4. The method according to claim 1, wherein the interface comprises a PCI(X) interface.

5. The method according to claim 5, wherein the multi-threaded DMA engine generates the plurality of requests to transfer data from/to the PCI(X) interface to/from a Fibre Channel interface.

6. A multi-threaded DMA engine data transfer system for a data processing system, comprising:
at least one frame buffer for storing data; and
a multi-threaded DMA engine for transferring data across an interface, the multi-threaded DMA engine generating a plurality of requests to transfer data over the interface, processing the plurality of requests using the at least one frame buffer and completing the plurality of transfer requests.

7. The system according to claim 6, wherein the multi-threaded DMA engine processes the plurality of requests in a desired order and reassembles the plurality of data requests after processing the plurality of requests in the desired order.

8. The system according to claim 6, wherein the at least one frame buffer comprises a plurality of frame buffers, and wherein the multi-threaded DMA engine processes the plurality of requests using the plurality of frame buffers.

9. The system according to claim 6, wherein the interface comprises a PCI(X) interface.

10. The system according to claim 9, wherein the multi-threaded DMA engine data transfer system is incorporated in a Fibre Channel controller.

11. The system according to claim 6, wherein the multi-threaded DMA engine data transfer system includes three interfaces.

12. The system according to claim 11, wherein the three interfaces include a Fibre Channel interface, a PCI(X) interface and an Advanced High Speed Bus interface.
